(19) United States
(12) Patent Application Publication
(10) Pub. No.: US 2026/0031441 A1
(43) Pub. Date: Jan. 29, 2026

(54) HEAT-SHRINK SLEEVE FILM AND SECONDARY BATTERY INCLUDING SUCH HEAT-SHRINK SLEEVE FILM

(71) Applicant: Ningde Amperex Technology Limited, Ningde (CN)

(72) Inventors: Huaxin GUO, Ningde (CN); Dongyang GUO, Ningde (CN)

(73) Assignee: Ningde Amperex Technology Limited, Ningde (CN)

(21) Appl. No.: 19/283,384

(22) Filed: Jul. 29, 2025

(30) Foreign Application Priority Data
Jul. 29, 2024 (CN) 202411026063.4

(51) Int. Cl. H01M 50/121; H01M 50/119; H01M 50/124

(52) U.S. Cl. CPC H01M 50/121; H01M 50/119; H01M 50/124

(57) ABSTRACT

A heat-shrink sleeve film includes a framework material and a functional polymer, where a glass transition temperature of the functional polymer is −80° C. to 50° C., and a glass transition temperature of the heat-shrink sleeve film is 10° C. to 65° C. The heat-shrink sleeve film releases its internal residual stress during processing or cycling of a battery, thereby alleviating the post shrinkage of a battery cell in a later stage of cycling, and improving the high- and low-temperature performance of the battery cell.

### CROSS REFERENCE TO RELATED APPLICATIONS

This application claims priority to the Chinese Patent Application Ser. No. 202411026063.4, filed on Jul. 29, 2024, the content of which is incorporated herein by reference in its entirety.

### TECHNICAL FIELD

This application relates to the field of battery technology, and in particular, to a heat-shrink sleeve film and a secondary battery including such heat-shrink sleeve film.

### BACKGROUND

During production of a cylindrical battery cell, a sleeve film is typically wrapped outside a steel shell of the battery cell and heated to induce transverse shrinkage to wrap a wall of the steel shell and induce longitudinal shrinkage to cover an end of the steel shell. However, residual stress is generated in the sleeve film during shrinkage. If this residual stress cannot be released during subsequent processing or cycling, post shrinkage of the sleeve film is easily caused in a later stage of cycling of the battery cell, that is, continuous shrinkage in a longitudinal direction leads to external exposure of the bare steel shell at the end, thus posing a risk of short circuit and affecting the safety and reliability of the battery cell.

### SUMMARY

In view of this, this application provides a heat-shrink sleeve film and a secondary battery including such heat-shrink sleeve film, where the heat-shrink sleeve film can release its internal residual stress during processing or cycling of a battery, thereby alleviating the post shrinkage of a battery cell in a later stage of cycling, and improving the high- and low-temperature performance of the battery cell.

According to a first aspect, this application provides a heat-shrink sleeve film, where the heat-shrink sleeve film includes a framework material and a functional polymer, a glass transition temperature of the functional polymer is −80° C. to 50° C., and a glass transition temperature of the heat-shrink sleeve film is less than or equal to 10° C. to 65° C. In this application, the heat-shrink sleeve film is controlled to include the functional polymer and the framework material (which is used to maintain strength and rigidity); in addition, the glass transition temperature (Tg) of the heat-shrink sleeve film is controlled to fall within the above range; and the glass transition temperature of the functional polymer is also controlled within the above range. In this case, molecular chain segments of the functional polymer can move at a relatively low temperature (near the glass transition temperature of the functional polymer), and this property is used to release the internal residual stress of the heat-shrink sleeve film through the movement of its molecular chain segments, improving the dimensional stability of the heat-shrink sleeve film throughout the entire service life of a battery, thereby alleviating the post shrinkage of a battery cell in a later stage (for example, the 400th cycle) of cycling (especially cycling at normal temperatures), and improving the high- and low-temperature performance of the battery cell. Preferably, the glass transition temperature of the functional polymer is −40° C. to 40° C., and the glass transition temperature of the heat-shrink sleeve film is 30° C. to 50° C. Based on a mass of the heat-shrink sleeve film, a mass percentage of the functional polymer is 10 wt % to 50 wt %, and a mass percentage of the framework material is 40 wt % to 88 wt %. A thickness of the heat-shrink sleeve film is 40 μm to 120 μm, the mass percentage of the functional polymer is 15 wt % to 50 wt %, and the mass percentage of the framework material is 40 wt % to 75 wt %. In some embodiments, the functional polymer includes at least one of acrylate rubber, a polyolefin elastomer, or a thermoplastic polyester elastomer. In particular, the acrylate rubber includes acrylate rubber with side-chain grafted methacrylate, the polyolefin elastomer includes an ethylene-octene copolymer grafted with glycidyl methacrylate or maleic anhydride, and the thermoplastic polyester elastomer includes a block copolymer composed of aromatic polyester chain segments and amorphous polyether or polyester chain segments.

In this application, the type of functional polymer is further controlled to be appropriate, so that the heat-shrink sleeve film has a better effect (better flexibility) of releasing internal residual stress during processing or cycling of the battery cell, better coordinates with an appropriate amount of framework materials, and has a more stable dimension, helping alleviate the post shrinkage of the sleeve film in the later stage of cycling and allowing for better high- and low-temperature performance. Preferably, the functional polymer includes an ethylene-octene copolymer and/or a block copolymer composed of aromatic polyester chain segments and amorphous polyether or polyester chain segments. More preferably, the functional polymer includes a polyester ether-type thermoplastic polyester elastomer formed by combining dimethyl terephthalate derivatives and polytetrahydrofuran ether diol derivatives. More preferably, the framework material includes at least one of polyethylene terephthalate, polybutylene terephthalate, or polytrimethylene terephthalate; and a crystallinity of the framework material is 5% to 55%.

In some embodiments, a molecular weight of the functional polymer is 10,000 g/mol to 200,000 g/mol, an elongation at break of the functional polymer is 500% to 1200%, and a tensile strength of the functional polymer is 20 MPa to 80 MPa. Controlling the molecular weight, elongation at break, and tensile strength of the functional polymer within the above ranges is more conducive to the release of internal residual stress in the heat-shrink sleeve film during processing or cycling of the battery cell, allows for better dimensional stability of the heat-shrink sleeve film, and is more conducive to alleviating the post shrinkage of the battery cell and improving the high- and low-temperature performance of the battery cell.

In some embodiments, a transverse shrinkage rate of the heat-shrink sleeve film is 40% to 50%, a longitudinal shrinkage rate of the heat-shrink sleeve film is 2% to 8%, and a residual shrinkage rate of the heat-shrink sleeve film is 2.5% to 5.5%. Controlling the transverse shrinkage rate, longitudinal shrinkage rate, and residual shrinkage rate of the heat-shrink sleeve film within the above ranges allows for better dimensional stability of the heat-shrink sleeve film throughout the entire usage process of the battery cell, and is more conducive to alleviating the post shrinkage of the battery cell during long-term room-temperature cycling and improving the high- and low-temperature performance of the battery cell.

In some embodiments, the heat-shrink sleeve film further includes a coloring material, where the coloring material includes polyethylene terephthalate-1,4-cyclohexanedimethanol ester and/or color powder; and based on a mass of the heat-shrink sleeve film, a mass percentage of the coloring material is 2 wt % to 10 wt %.

In some embodiments, the heat-shrink sleeve film is obtained by mixing and drying the framework material, the functional polymer, and the coloring material at 260° C. to 290° C., followed by extruding at 180° C. to 250° C., and expanding and stretching at 95° C. to 105° C.

According to a second aspect, this application provides a secondary battery, where the secondary battery includes a cylindrical shell and a heat-shrink sleeve film sleeved on an outer side of a wall of the cylindrical shell, the heat-shrink sleeve film includes a first portion covering the wall of the cylindrical shell and a second portion covering an end of the cylindrical shell, and the first portion and the second portion are integrally formed; and the heat-shrink sleeve film is the heat-shrink sleeve film according to any one of these embodiments of the first aspect.

In some embodiments, an outer diameter of the cylindrical shell is 16 mm to 70 mm.

The technical solutions provided by some embodiments of this application bring at least the following beneficial effects: This application provides a heat-shrink sleeve film, where the heat-shrink sleeve film includes a framework material and a functional polymer. In this application, when the glass transition temperatures of the heat-shrink sleeve film and the functional polymer are controlled to be appropriate, the functional polymer can synergistically cooperate with the framework material to release the internal residual stress of the heat-shrink sleeve film through the movement of its molecular chain segments, thereby alleviating the post shrinkage of a battery cell in a later stage of cycling, and improving the high- and low-temperature performance of the battery cell.

### BRIEF DESCRIPTION OF DRAWINGS

To describe the technical solutions in some embodiments of this application or the prior art more clearly, the following briefly describes the accompanying drawings required for describing some embodiments or the prior art. Apparently, the accompanying drawings in the following description show merely some embodiments of this application, and persons of ordinary skill in the art may still derive other accompanying drawings from these accompanying drawings without creative efforts.

FIG. 1 is a schematic structural diagram of a heat-shrink sleeve film described in this application.

In the drawings: 1. framework material; 2. functional polymer; and 3. coloring material.

### DETAILED DESCRIPTION

To make the objectives, technical solutions, and advantages of this application clearer and more comprehensible, the following further describes this application in detail with reference to the accompanying drawings and some embodiments. It should be understood that the specific embodiments described herein are merely intended to explain this application rather than to limit this application.

To meet the current market demands, cylindrical batteries have been comprehensively improved in terms of high rate, high capacity, and long service life, posing greater challenges to structural design and imposing higher requirements on raw materials used in battery cells, where the raw materials include various packaging and insulating materials of the battery cells, such as sleeve films. To achieve a higher energy density, multiple battery cells need to be connected and fixed to form a module, ultimately forming a battery pack. In this process, these battery cells need to be in contact with each other, even in close contact with each other, while remaining mutually insulated and stable. Typically, the exterior of a steel shell of a cylindrical battery cell is wrapped with a blue film or a sleeve film to provide insulation and protection, preventing short circuits and electricity leakage in a battery to ensure the stability of the battery during use.

Traditional sleeve film materials use polyethylene terephthalate (PET) or polyethylene terephthalate-1,4-cyclohexanedimethanol ester (PETG), with a glass transition temperature typically ranging from 70° C. to 80° C. These materials have good insulation and wear resistance. However, when power-type batteries discharge and surface temperatures of battery cells rise significantly, the surface temperatures of the batteries may approach the glass transition temperature range of the traditional sleeve film materials. As the residual stress within the sleeve films is released, the dimensions of the traditional sleeve films cannot remain stable, leading to post shrinkage of the sleeve films in the battery cells in the later stages of cycling, where the sleeve films continuously shrink longitudinally and fail to cover the heads or the tails of the batteries, resulting in external exposure of bare steel shells, thus posing a risk of short circuit and affecting the safety and reliability of the battery cells. To address this issue, some technologies employ long-term high-temperature baking or long-term static aging to reduce residual stress in the sleeve films. However, these methods may lead to low production efficiency and performance issues such as increased impedance or reduced energy density of the batteries. There is an urgent need to design materials such that residual stress in the materials is effectively released during processing or cycling of the batteries.

A main objective of this application is to alleviate the post shrinkage of the heat-shrink sleeve film. A polymer framework (framework material) for maintaining strength and rigidity is provided in raw material components of the heat-shrink sleeve film used in this application, and a flexible polymer (functional polymer) is added for packing. The flexible polymer used has good flexibility and a low glass transition temperature, allowing its molecular chain segments to move at lower temperatures. This property is used to release the internal residual stress of the sleeve film through the movement of its molecular chain segments, ensuring the dimensional stability of the sleeve film throughout the entire service life of a battery cell, thereby helping alleviate the post shrinkage of the battery cell during long-term cycling and improve the high- and low-temperature performance of the battery cell.

### Heat-Shrink Sleeve Film

According to a first aspect of an embodiment of this application, a heat-shrink sleeve film is provided. The heat-shrink sleeve film includes a framework material and a functional polymer, where a glass transition temperature of the functional polymer is −80° C. to 50° C., and the functional polymer includes at least one of nitrile rubber, thermoplastic styrene-butadiene rubber, hydrogenated thermoplastic styrene-butadiene rubber, ethylene-propylene rubber, acrylate rubber, a polyolefin elastomer, or a thermoplastic polyester elastomer. A glass transition temperature of the heat-shrink sleeve film is 10° C. to 65° C. Based on a mass of the heat-shrink sleeve film, a mass percentage of the functional polymer is 10 wt % to 50 wt %, and a mass percentage of the framework material is 40 wt % to 88 wt %. For example, the glass transition temperature of the functional polymer is −80° C., −60° C., −40° C., −20° C., −10° C., 0° C., 20° C., 25° C., 30° C., 32° C., 35° C., 40° C., 43° C., 45° C., 48° C., or 50° C., or falls within a range defined by any two of these values. For example, the glass transition temperature of the heat-shrink sleeve film is 10° C., 15° C., 20° C., 25° C., 30° C., 35° C., 40° C., 45° C., 50° C., 55° C., or 65° C. Further preferably, the glass transition temperature of the heat-shrink sleeve film is 30° C. to 50° C. Based on the mass of the heat-shrink sleeve film, the mass percentage of the functional polymer is 10 wt % to 50 wt %, and the mass percentage of the framework material is 40 wt % to 88 wt %. For example, the mass percentage of the functional polymer is 10 wt %, 12 wt %, 15 wt %, 20 wt %, 25 wt %, 30 wt %, 35 wt %, 40 wt %, 45 wt %, or 50 wt %, or falls within a range defined by any two of these values. For example, the mass percentage of the framework material is 40 wt %, 45 wt %, 50 wt %, 55 wt %, 60 wt %, 65 wt %, 70 wt %, 75 wt %, 80 wt %, 85 wt %, or 88 wt %, or falls within a range defined by any two of these values. A polymer framework for maintaining strength and rigidity is provided in raw material components of the heat-shrink sleeve film used in this application. The glass transition temperature of the heat-shrink sleeve film and the glass transition temperature of the functional polymer are controlled, and a flexible polymer is used for packing. The flexible polymer has good flexibility and a low glass transition temperature, allowing its molecular chain segments to move at lower temperatures. This property is used to release the internal residual stress of the sleeve film through the movement of its molecular chain segments, ensuring the dimensional stability of the sleeve film throughout the entire service life of a battery. Specifically, in this application, the heat-shrink sleeve film is controlled to include the functional polymer (flexible polymer) and the framework material (polymer framework material used for maintaining strength and rigidity); in addition, the glass transition temperature (Tg) of the functional polymer is synergistically controlled to fall within the above range; and the mass percentages of the functional polymer and the framework material are also controlled within the above range. In this case, the molecular chain segments of the functional polymer can move at a relatively low temperature (near the glass transition temperature of the functional polymer), and this property is used to release the internal residual stress of the heat-shrink sleeve film through the movement of its molecular chain segments, ensuring the dimensional stability of the heat-shrink sleeve film throughout the entire service life of the battery, thereby helping alleviate the post shrinkage of the battery in a later stage (for example, the 400th cycle) of cycling at room temperature and improve the high- and low-temperature performance of the battery.

In some embodiments, the mass percentage of the functional polymer is 10 wt %, 12 wt %, 15 wt %, 20 wt %, 25 wt %, 30 wt %, 35 wt %, 40 wt %, 45 wt %, or 50 wt %, or falls within a range defined by any two of these values. For example, the mass percentage of the framework material is 40 wt %, 45 wt %, 50 wt %, 55 wt %, 60 wt %, 65 wt %, 70 wt %, 75 wt %, 80 wt %, 85 wt %, or 88 wt %, or falls within a range defined by any two of these values. In some embodiments, the functional polymer includes at least one of acrylate rubber, a polyolefin elastomer, or a thermoplastic polyester elastomer, where the acrylate rubber includes acrylate rubber with side-chain grafted methacrylate, the polyolefin elastomer includes an ethylene-octene copolymer grafted with glycidyl methacrylate or maleic anhydride, and the thermoplastic polyester elastomer includes a block copolymer composed of aromatic polyester chain segments and amorphous polyether or polyester chain segments. In this case, the heat-shrink sleeve film a better effect of releasing internal residual stress during processing or cycling of the battery, and has a more stable dimension, helping alleviate the post shrinkage of the heat-shrink sleeve film in the later stage of long-term room-temperature cycling and improve the high- and low-temperature performance of the battery. Preferably, the functional polymer includes an ethylene-octene copolymer and/or a block copolymer composed of aromatic polyester chain segments and amorphous polyether or polyester chain segments. More preferably, the functional polymer includes a polyester ether-type thermoplastic polyester elastomer formed by combining dimethyl terephthalate derivatives and polytetrahydrofuran ether diol derivatives.

In some embodiments, a molecular weight of the functional polymer is 10,000 g/mol to 200,000 g/mol, an elongation at break of the functional polymer is 500% to 1200%, a tensile strength of the functional polymer is 20 MPa to 80 MPa, and a thickness of the heat-shrink sleeve film is 40 μm to 120 μm. For example, the molecular weight of the functional polymer is 10,000 g/mol, 20,000 g/mol, 30,000 g/mol, 50,000 g/mol, 80,000 g/mol, 100,000 g/mol, 150,000 g/mol, or 200,000 g/mol, or falls within a range defined by any two of these values. For example, the elongation at break of the functional polymer is 500%, 550%, 650%, 750%, 850%, 950%, 1000%, 1100%, or 1200%, or falls within a range defined by any two of these values. For example, the tensile strength of the functional polymer is 20 MPa, 25 MPa, 30 MPa, 35 MPa, 45 MPa, 50 MPa, 60 MPa, 75 MPa, or 80 MPa, or falls within a range defined by any two of these values. For example, the thickness of the heat-shrink sleeve film is 40 μm, 60 μm, 80 μm, 90 μm, 100 μm, 110 μm, or 120 μm, or falls within a range defined by any two of these values.

In some embodiments, a crystallinity of the framework material is 5% to 55%, and the framework material includes at least one of polyethylene terephthalate, polybutylene terephthalate, polytrimethylene terephthalate, polyvinyl chloride resin, or polyamide resin, with an intrinsic viscosity of 0.6 dl/g to 1.0 dl/g and a melt index of 5 g/10 min to 50 g/10 min. An appropriate crystallinity of the framework material is more conducive to compatibility of the framework material with the functional polymer of this application, alleviating the post shrinkage of the battery, and improving the high- and low-temperature performance of the battery. In particular, when the type, intrinsic viscosity, and melt index of the framework material also fall within the above ranges, the effects of alleviating the post shrinkage of the battery and improving the high- and low-temperature performance of the battery are better. For example, the crystallinity of the framework material is 5%, 10%, 15%, 20%, 25%, 30%, 35%, 40%, 45%, 50%, or 55%, or falls within a range defined by any two of these values. For example, the intrinsic viscosity of the framework material is 0.6 dl/g, 0.65 dl/g, 0.7 dl/g, 0.75 dl/g, 0.8 dl/g, 0.85 dl/g, 0.9 dl/g, 0.95 dl/g, or 1.0 dl/g, or falls within a range defined by any two of these values. For example, the melt index of the framework material is 5 g/10 min, 10 g/10 min, 15 g/10 min, 20 g/10 min, 30 g/10 min, 35 g/10 min, or 50 g/10 min, or falls within a range defined by any two of these values.

In some embodiments, a transverse shrinkage rate of the heat-shrink sleeve film is 40% to 50%, a longitudinal shrinkage rate of the heat-shrink sleeve film is 2% to 8%, and a residual shrinkage rate of the heat-shrink sleeve film is 2.5% to 5.5%. For example, the transverse shrinkage rate of the heat-shrink sleeve film is 40%, 42%, 43%, 45%, 47%, 48%, 49%, or 50%, or falls within a range defined by any two of these values. For example, the longitudinal shrinkage rate of the heat-shrink sleeve film is 2%, 3%, 5%, 5.5%, 6%, 6.5%, 7%, or 8%, or falls within a range defined by any two of these values. For example, the residual shrinkage rate of the heat-shrink sleeve film is 2.5%, 2.6%, 2.8%, 3.0%, 3.2%, 3.3%, 3.5%, 3.6%, 3.7%, 3.8%, 4%, 4.3%, 4.5%, 4.8%, 5%, 5.3%, or 5.5%, or falls within a range defined by any two of these values. Controlling the transverse shrinkage rate, longitudinal shrinkage rate, and residual shrinkage rate of the heat-shrink sleeve film within the above ranges helps maintain the dimensional stability of the heat-shrink sleeve film throughout the entire usage process of the battery.

The residual shrinkage rate is equal to (Z3−Z4)/Z3×100%, where Z3 represents a length of the heat-shrink sleeve film in a longitudinal MD direction, and Z4 represents a length of the heat-shrink sleeve film in the longitudinal MD direction after being boiled in 98±2° C. boiling water for 30 s.

In some embodiments, the heat-shrink sleeve film further includes a coloring material, where the coloring material includes polyethylene terephthalate-1,4-cyclohexanedimethanol ester and/or color powder; and based on the mass of the heat-shrink sleeve film, a mass percentage of the coloring material is 2 wt % to 10 wt %. Illustratively, the mass percentage of the coloring material is 2 wt %, 3 wt %, 5 wt %, 6 wt %, 8 wt %, or 10 wt %, or falls within a range defined by any two of these values.

In some embodiments, the heat-shrink sleeve film is obtained by mixing and drying the framework material, the functional polymer, and the coloring material at 260° C. to 290° C., followed by extruding at 180° C. to 250° C., and expanding and stretching at 95° C. to 105° C. This can alleviate the post shrinkage of the battery and improve the high- and low-temperature performance of the battery.

The following describes possible embodiments.

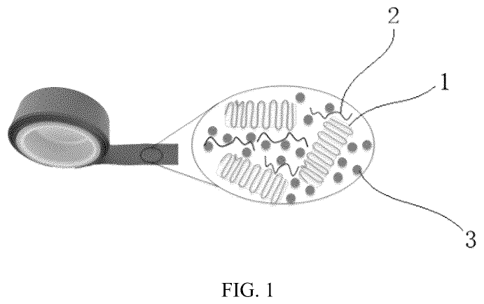

Referring to FIG. 1, a heat-shrink sleeve film material includes: a polymer framework material (framework material) 1, where the polymer framework material includes at least one of polyethylene terephthalate (PET), polybutylene terephthalate (PBT), polytrimethylene terephthalate (PTT), polyvinyl chloride resin (PVC), or polyamide resin (PA); a flexible polymer (functional polymer) 2, where the flexible polymer includes at least one of nitrile rubber (NBR), ethylene-propylene rubber (EPM), thermoplastic styrene-butadiene rubber (SBS), hydrogenated SBS (SEBS), acrylate rubber (ACM), a polyolefin elastomer (POE), an ethylene-acrylate-glycidyl methacrylate copolymer (E-MA-GMA), or a thermoplastic polyester elastomer (TPEE); and a coloring material 3, where the coloring material includes polyethylene terephthalate-1,4-cyclohexanedimethanol ester (PETG) and color powder as optional.

Further, the heat-shrink sleeve film has a glass transition temperature of 30° C. to 50° C., a thickness of 40 μm to 120 μm, a transverse shrinkage rate of 40% to 50%, and a longitudinal shrinkage rate of 2% to 8%.

Further, a weight percentage of the polymer framework material in the heat-shrink sleeve film material is 40% to 88%.

Further, the polymer framework material has a crystallinity of 5% to 55% and a tensile strength of 20 MPa to 80 MPa.

Further, a weight percentage of the flexible polymer in the heat-shrink sleeve film material is 10% to 50%.

Further, the flexible polymer has a glass transition temperature of −80° C. to 50° C., an elongation at break of 500% to 1200%, and a molecular weight of 10,000 g/mol to 200,000 g/mol.

Further, a weight percentage of the coloring material in the heat-shrink sleeve film material is 2% to 10%.

### Preparation Process of Heat-Shrink Sleeve Film

1. Mixing and granulation: polymer framework particles, flexible polymer particles, and coloring particles are mixed at a ratio, and the resulting mixture is fed into granulation equipment for mixing and extrusion granulation, with a mixing temperature of 260° C. to 290° C.

2. Extrusion of tube: Masterbatches produced in the first step are dried in an oven at 60° C. to 80° C. for 6 to 12 h and extruded into a tube through an extruder and a tubular mold at a temperature of 180° C. to 250° C.

3. Expansion and stretching: The tube is heated and then subjected to transverse expansion and longitudinal stretching through an expansion mold and a traction roller, with a heating temperature of 95° C. to 105° C. A shrinkage rate of a heat-shrink tube is −4% in MD and −43% in TD.

### Cylindrical Battery

The cylindrical battery includes a jelly roll, a steel shell, and a sleeve film, where the sleeve film includes the heat-shrink sleeve film according to any one of foregoing embodiments.

Further, the jelly roll includes a positive electrode, where the positive electrode includes a current collector and at least one active material selected from lithium cobaltate, lithium iron phosphate, lithium manganate, or a ternary material.

Further, the jelly roll includes a negative electrode, where the negative electrode includes a current collector and at least one active material selected from graphite, silicon, silicon carbon, or hard carbon.

Further, the jelly roll includes a separator, where the separator includes a coating and at least one substrate selected from polyethylene, polypropylene, polyvinylidene fluoride, polyimide, or polyisophthalamide.

Further, an outer diameter of the cylindrical battery is 16 mm to 70 mm.

With a cylindrical steel-shell lithium-ion battery with an internal wound electrode assembly as an example, parameter verification tests for the heat-shrink sleeve film solution were conducted. The cylindrical steel-shell lithium-ion battery had an outer diameter of 21 mm and a height of 70 mm. The sleeve films in the following examples and comparative examples were all verified using this cylindrical steel-shell lithium-ion battery.

The thermoplastic polyester elastomer was selected from KP3340, KP3355, KP3372 (KOLON Company), or Hytrel 6356 (DuPont Company).

This application had no special restrictions on the POE, and POEs from the Dow series (USA), ExxonMobil series (USA), Mitsui TAFMER series (Japan), or LG Chem series (Korea) can be used. For example, in this application, POE A1 was a POE purchased from Mitsui Company under the grade DF610, POE A2 was a POE purchased from Dow Company under the grade 8842, POE A3 was a POE purchased from LG Chem Company under the grade LC180, and POE A4 was a POE purchased from Mitsui Company under the grade DF605.

The acrylate rubber was acrylate rubber with side-chain grafted methacrylate and was purchased from Rohm and Haas Company under the grade KM355P.

### Example 1-1

### <Preparation of Heat-Shrink Sleeve Film>

Step 1. Mixing and granulation: The framework material, the functional polymer, and the coloring material are mixed at a ratio, and the resulting mixture is fed into granulation equipment for mixing and extrusion granulation to obtain masterbatches, with a mixing temperature of 280±5° C. The parameters of the framework material, the functional polymer, and the coloring material are shown in Table 1.

Step 2. Extrusion of tube: The masterbatches obtained from step 1 are dried in an oven at 70±5° C. for 12 h and extruded into a tube through an extruder and a tubular mold at a temperature of 230±5° C.

Step 3. Expansion and stretching: The tube is heated and then subjected to transverse expansion and longitudinal stretching through an expansion mold and a traction roller, with a heating temperature of 100±5° C. A shrinkage rate of a heat-shrink tube is −4% in MD and −43% in TD, and a thickness of a heat-shrink sleeve film is 70 μm.

### <Preparation of Cylindrical Steel-Shell Lithium-Ion Battery Including Heat-Shrink Sleeve Film>

The positive electrode, the separator, and the negative electrode are in close contact with each other sequentially, and an electrode unit is obtained through winding and stacking. The electrode unit, along with the electrolyte, is sealed in a steel shell. The prepared heat-shrink sleeve film is sleeved on the exterior of the steel shell and subjected to high-temperature heat shrinking (at 300±60° C. for 10-30 s), followed by tightly wrapping to obtain a product.

### Test Methods:

### 1. DSC Test

2 mg to 5 mg of a sleeve film (heat-shrink sleeve film) sample was taken and subjected to DSC test. A test temperature range was 0° C. to 300° C. The temperature rose at a heating speed of 10° C./min. A secondary heating curve was analyzed, and a glass transition temperature and crystallinity of the sleeve film were recorded.

### 2. Test for Transverse Shrinkage Rate and Longitudinal Shrinkage Rate

A 100 mm fresh sleeve film not subjected to heat shrinkage was taken, and a dimension X1 in a transverse direction (TD direction) and a dimension Z1 in a longitudinal direction (MD direction) of the sleeve film sample were measured. The heat-shrink film was boiled in boiling water at 98±2° C. for 30 s and then taken out. The dimensions of the same numbered sleeve film in the TD and MD directions after boiled in water were measured respectively. An average dimension of each sample in the TD direction was recorded as X2 and an average dimension of each sample in the MD direction was recorded as Z2. If an edge of the sample exhibited uneven shrinkage, a position with the maximum shrinkage was used as the reference. The transverse direction and longitudinal direction of the sleeve film were directions conventionally used in the art.

The transverse heat shrinkage rate was calculated as (X1−X2)/X1×100%, and the longitudinal heat shrinkage rate was equal to (Z1−Z2)/Z1×100%.

### 3. Test for Residual Shrinkage Rate

A sleeve film sample was taken from a cylindrical battery wrapped with the sleeve film, and a reference line of a specified length (30 mm to 60 mm) was marked on the sleeve film in the longitudinal direction (MD direction). The length Z3 of the reference line was measured and recorded. The sleeve film sample with the marked reference line was boiled in boiling water at 98±2° C. for 30 s and then taken out. A dimension Z4 of the same numbered sleeve film in the MD direction after boiled in water was measured.

The residual shrinkage rate of the sleeve film after heat shrinkage was equal to (Z3−Z4)/Z3×100%.

4. Test for Post Shrinkage after Room-Temperature Cycles (400 Cycles 25° C.)

The cylindrical battery wrapped with the sleeve film was subjected to formation, and an initial position reference line was marked at an edge of a bottom of the battery wrapped with the sleeve film. Charge-discharge cycle test was conducted in a constant-temperature chamber at 25° C., with a charge-discharge voltage range of 3.0 V to 4.2 V. The battery was charged to 4.2 V at a rate of 2C, then charged to 0.05C at a constant voltage of 4.2 V and left standing for 10 minutes, and then discharged to 3 V at a rate of 7.5C. 400 charge-discharge cycles were performed. A shrinkage dimension of the sleeve film at the bottom relative to the initial position was measured, and a sleeve film shrinkage dimension less than or equal to 2 mm was considered qualified, recorded as pass.

5. Test for Shrinkage after High- and Low-Temperature Cycles (80 High- and Low-Temperature Cycles)

The cylindrical battery wrapped with the sleeve film was subjected to formation, and an initial position reference line was marked at an edge of a bottom of the battery wrapped with the sleeve film. The battery was placed in a thermal shock test chamber and maintained at a high temperature of 65° C. for 60 min and a low temperature of −40° C. for 60 min, with a temperature transition time of less than 10 minutes. 80 cycles were performed. A shrinkage dimension of the sleeve film at the bottom relative to the initial position was measured, and a sleeve film shrinkage dimension less than or equal to 2 mm was considered qualified, recorded as pass.

### Examples 1-2 to 1-14

These examples were the same as Example 1-1 except that the parameters were adjusted according to Table 1.

### Comparative Examples 1 to 7

These examples were the same as Example 1-1 except that the parameters were adjusted according to Table 1.

TABLE 1

| | | | Functional polymer | | | Heat-shrink | |
|---|---|---|---|---|---|---|---|
| | Framework material | | Tg | | Molecular | sleeve film Tg | Coloring |
| | | Type and | temperature | Type and | weight | temperature | material |
| | Crystallinity | percentage | (° C.) | percentage | (g/mol ) | (° C.) | (percentage) |
| Example 1-1 | 20% | PET (88%) | 40 | KP3355 | 10,000- | 65 | PETG + purple |
| | | | | (10%) | 50,000 | | powder (2%) |
| Example 1-2 | 20% | PET (75%) | 40 | KP3355 | 10,000- | 60 | PETG + purple |
| | | | | (15%) | 50,000 | | powder (10%) |
| Example 1-3 | 20% | PET (70%) | 40 | KP3355 | 10,000- | 40 | PETG + purple |
| | | | | (20%) | 50,000 | | powder (10%) |
| Example 1-4 | 20% | PET (65%) | 40 | KP3355 | 10,000- | 30 | PETG + purple |
| | | | | (25%) | 50,000 | | powder (10%) |
| Example 1-5 | 20% | PET (65%) | −80 | POE A1 | 40,000- | 10 | PETG + purple |
| | | | | (25%) | 100,000 | | powder (10%) |
| Example 1-6 | 20% | PET (65%) | −60 | POE A2 | 40,000- | 20 | PETG + purple |
| | | | | (25%) | 100,000 | | powder (10%) |
| Example 1-7 | 20% | PET (65%) | −40 | POE A3 | 40,000- | 30 | PETG + purple |
| | | | | (25%) | 100,000 | | powder (10%) |
| Example 1-8 | 20% | PET (65%) | 0 | POE A4 | 40,000- | 50 | PETG + purple |
| | | | | (25%) | 100,000 | | powder (10%) |
| Example 1-9 | 20% | PET (65%) | 50 | KP3372 | 10,000- | 65 | PETG + purple |
| | | | | (25%) | 50,000 | | powder (10%) |
| Example 1-10 | 20% | PET (75%) | 20 | Hytrel | 10,000- | 55 | PETG + purple |
| | | | | 6356 | 50,000 | | powder (10%) |
| | | | | (15%) | | | |
| Example 1-11 | 20% | PET (65%) | −20 | Acrylate | 50,000- | 55 | PETG + purple |
| | | | | rubber | 200,000 | | powder (10%) |
| | | | | (25%) | | | |
| Example 1-12 | 20% | PET (40%) | 30 | KP3340 | 10,000- | 30 | PETG + purple |
| | | | | (50%) | 50,000 | | powder (10%) |
| Example 1-13 | 20% | PET (65%) | 45 | KP3355 | 40,000- | 32 | PETG + purple |
| | | | | (25%) | 100,000 | | powder (10%) |
| Comparative | 20% | PET (65%) | 58 | KP3372 | 10,000- | 70 | PETG + purple |
| Example 1 | | | | (25%) | 50,000 | | powder (10%) |
| Comparative | 20% | PET (65%) | −90 | POE A1 | 40,000- | 0 | PETG + purple |
| Example 2 | | | | (25%) | 100,000 | | powder (10%) |
| Comparative | 20% | PET (85%) | 40 | KP3355 | 10,000- | 68 | PETG + purple |
| Example 3 | | | | (5%) | 50,000 | | powder (10%) |
| Comparative | 20% | PET (35%) | 40 | KP3355 | 10,000- | 8 | PETG + purple |
| Example 4 | | | | (55%) | 50,000 | | powder (10%) |
| Comparative | 20% | PET (40%) | 72 | PET | 150,000- | 72 | PETG + purple |
| Example 5 | | | | (50%) | 220,000 | | powder (10%) |
| Comparative | 20% | PET (91%) | 40 | KP3355 | 10,000- | 70 | PETG + purple |
| Example 6 | | | | (5%) | 50,000 | | powder (4%) |
| Comparative | 20% | PET (91%) | 58 | KP3372 | 10,000- | 72 | PETG + purple |
| Example 7 | | | | (5%) | 50,000 | | powder (4%) |
| Example 1-14 | 20% | PET (65%) | 40 | KP3355 | 10,000- | 30 | PETG + purple |
| | | | | (25%) | 50,000 | | powder (12%) |

Note:
PETG is polyethylene terephthalate-1,4-cyclohexanedimethanol ester.

TABLE 2

| | Heat-shrink sleeve film | | | | Post shrinkage |
|---|---|---|---|---|---|
| | Transverse | Longitudinal | Residual | Post shrinkage | after |
| | shrinkage | shrinkage | shrinkage | after 400 cycles | 80 high- and low- |
| | rate | rate | rate | at 25° C. | temperature cycles |
| Example 1-1 | 43% | 6.0% | 5.2% | 8 Pass/10 Total | 8 Pass/10 Total |
| Example 1-2 | 43% | 5.6% | 4.8% | 9 Pass/10 Total | 9 Pass/10 Total |
| Example 1-3 | 42% | 5.5% | 4.1% | 10 Pass/10 Total | 10 Pass/10 Total |
| Example 1-4 | 41% | 5.4% | 2.5% | 10 Pass/10 Total | 10 Pass/10 Total |
| Example 1-5 | 49% | 7.0% | 5.5% | 6 Pass/10 Total | 7 Pass/10 Total |
| Example 1-6 | 46% | 6.6% | 5.2% | 7 Pass/10 Total | 7 Pass/10 Total |
| Example 1-7 | 45% | 5.5% | 4.6% | 9 Pass/10 Total | 9 Pass/10 Total |
| Example 1-8 | 42% | 5.0% | 4.4% | 9 Pass/10 Total | 9 Pass/10 Total |
| Example 1-9 | 49% | 7.0% | 5.3% | 7 Pass/10 Total | 8 Pass/10 Total |
| Example 1-10 | 46% | 5.6% | 4.3% | 9 Pass/10 Total | 9 Pass/10 Total |
| Example 1-11 | 43% | 6.1% | 4.6% | 9 Pass/10 Total | 9 Pass/10 Total |
| Example 1-12 | 43% | 6.2% | 4.5% | 9 Pass/10 Total | 9 Pass/10 Total |
| Example 1-13 | 45% | 5.5% | 4.7% | 9 Pass/10 Total | 9 Pass/10 Total |
| Example 1-14 | 44% | 5.8% | 2.8% | 9 Pass/10 Total | 9 Pass/10 Total |
| Comparative | 43% | 9.0% | 8.0% | 0 Pass/10 Total | 0 Pass/10 Total |
| Example 1 | | | | | |
| Comparative | 43% | 10.0% | 7.6% | 0 Pass/10 Total | 0 Pass/10 Total |
| Example 2 | | | | | |
| Comparative | 47% | 9.3% | 7.5% | 2 Pass/10 Total | 2 Pass/10 Total |
| Example 3 | | | | | |
| Comparative | 49% | 9.8% | 8.5% | 1 Pass/10 Total | 1 Pass/10 Total |
| Example 4 | | | | | |
| Comparative | 43% | 6.0% | 9.0% | 0 Pass/10 Total | 0 Pass/10 Total |
| Example 5 | | | | | |
| Comparative | 46% | 6.5% | 9.2% | 0 Pass/10 Total | 0 Pass/10 Total |
| Example 6 | | | | | |
| Comparative | 48% | 6.6% | 9.1% | 0 Pass/10 Total | 0 Pass/10 Total |
| Example 7 | | | | | |

Referring to Table 1, from comparison of Comparative Examples 1 to 7 with Examples 1-1 to 1-14, it can be seen that when the glass transition temperature of the heat-shrink sleeve film and the glass transition temperature of the functional polymer do not satisfy the ranges of this application, the residual shrinkage rates of the heat-shrink sleeve films in Comparative Examples 1 to 7 are all relatively high (poor dimensional stability), which are 7.5% or above, and there is essentially no alleviation or only insignificant alleviation in post shrinkage during long-term room-temperature cycling. The residual shrinkage rate of the heat-shrink sleeve film in Example 1-1 is significantly reduced to 5.2%, and the battery including this heat-shrink sleeve film shows a significant alleviation in post shrinkage after 400 cycles at 25° C., with a pass rate significantly increased to 80%, and there is significant improvement in the high- and low-temperature performance. In particular, further controlling the glass transition temperature of the functional polymer and the percentages of the framework material and the functional polymer within the preferred ranges improves the dimensional stability of the heat-shrink sleeve film and allows for a better effect of alleviating the post shrinkage during long-term room-temperature cycling.

The foregoing descriptions are merely preferred embodiments of this application, but are not intended to limit this application. Any modification, equivalent replacement, or improvement made without departing from the spirit and principle of this application shall fall within the protection scope of this application.

What is claimed is:

1. A heat-shrink sleeve film for a secondary battery, wherein the heat-shrink sleeve film comprises a framework material and a functional polymer, and a glass transition temperature of the functional polymer is in a range of −80° C. to 50° C.; and
a glass transition temperature of the heat-shrink sleeve film is in a range of 10° C. to 65° C.

2. The heat-shrink sleeve film according to claim 1, wherein the glass transition temperature of the heat-shrink sleeve film is in a range of 30° C. to 50° C.

3. The heat-shrink sleeve film according to claim 1, wherein the functional polymer comprises at least one of acrylate rubber, a polyolefin elastomer, or a thermoplastic polyester elastomer;
the acrylate rubber comprises acrylate rubber with side-chain grafted methacrylate;
the polyolefin elastomer comprises an ethylene-octene copolymer grafted with glycidyl methacrylate or maleic anhydride; and
the thermoplastic polyester elastomer comprises a block copolymer composed of aromatic polyester chain segments and amorphous polyether or polyester chain segments.

4. The heat-shrink sleeve film according to claim 3, wherein the functional polymer comprises the thermoplastic polyester elastomer; and the thermoplastic polyester elastomer comprises a polyester ether-type thermoplastic polyester elastomer formed by combining dimethyl terephthalate derivatives and polytetrahydrofuran ether diol derivatives.

5. The heat-shrink sleeve film according to claim 1, wherein at least one of the following conditions is satisfied:
(1) the glass transition temperature of the functional polymer is in a range of −40° C. to 40° C.;
(2) a molecular weight of the functional polymer is in a range of 10,000 g/mol to 200,000 g/mol;
(3) a tensile strength of the functional polymer is in a range of 20 MPa to 80 MPa; or
(4) an elongation at break of the functional polymer is in a range of 500% to 1200%.

6. The heat-shrink sleeve film according to claim 1, wherein at least one of the following conditions is satisfied:
(1) based on a mass of the heat-shrink sleeve film, a mass percentage of the functional polymer is in a range of 10 wt % to 50 wt %, and a mass percentage of the framework material is in a range of 40 wt % to 88 wt %; or
(2) a thickness of the heat-shrink sleeve film is in a range of 40 μm to 120 μm.

7. The heat-shrink sleeve film according to claim 1, wherein the framework material comprises at least one of polyethylene terephthalate, polybutylene terephthalate, or polytrimethylene terephthalate; and a crystallinity of the framework material is in a range of 5% to 55%.

8. The heat-shrink sleeve film according to claim 3, wherein at least one of the following conditions is satisfied:
(1) a transverse shrinkage rate of the heat-shrink sleeve film is in a range of 40% to 50%;
(2) a longitudinal shrinkage rate of the heat-shrink sleeve film is in a range of 2% to 8%; or
(3) a residual shrinkage rate of the heat-shrink sleeve film is in a range of 2.5% to 5.5%.

9. The heat-shrink sleeve film according to claim 1, wherein the heat-shrink sleeve film further comprises a coloring material;
the coloring material comprises polyethylene terephthalate-1,4-cyclohexanedimethanol ester and/or color powder; and
based on a mass of the heat-shrink sleeve film, a mass percentage of the coloring material is in a range of 2 wt % to 10 wt %.

10. A secondary battery, wherein the secondary battery comprises a cylindrical shell and a heat-shrink sleeve film sleeved on an outer side of a wall of the cylindrical shell, the heat-shrink sleeve film comprises a first portion covering the wall of the cylindrical shell and a second portion covering an end of the cylindrical shell, and the first portion and the second portion are integrally formed; and
the heat-shrink sleeve film comprises a framework material and a functional polymer, and a glass transition temperature of the functional polymer is in a range of −80° C. to 50° C.; and
a glass transition temperature of the heat-shrink sleeve film is in a range of 10° C. to 65° C.

11. The secondary battery according to claim 10, wherein the glass transition temperature of the heat-shrink sleeve film is in a range of 30° C. to 50° C.

12. The secondary battery according to claim 10, wherein the functional polymer comprises at least one of acrylate rubber, a polyolefin elastomer, or a thermoplastic polyester elastomer;
the acrylate rubber comprises acrylate rubber with side-chain grafted methacrylate;
the polyolefin elastomer comprises an ethylene-octene copolymer grafted with glycidyl methacrylate or maleic anhydride; and
the thermoplastic polyester elastomer comprises a block copolymer composed of aromatic polyester chain segments and amorphous polyether or polyester chain segments.

13. The secondary battery according to claim 10, wherein the functional polymer comprises the thermoplastic polyester elastomer; and the thermoplastic polyester elastomer comprises a polyester ether-type thermoplastic polyester elastomer formed by combining dimethyl terephthalate derivatives and polytetrahydrofuran ether diol derivatives.

14. The secondary battery according to claim 10, wherein at least one of the following conditions is satisfied:
(1) the glass transition temperature of the functional polymer is in a range of −40° C. to 40° C.;
(2) a molecular weight of the functional polymer is in a range of 10,000 g/mol to 200,000 g/mol;
(3) a tensile strength of the functional polymer is in a range of 20 MPa to 80 MPa; or
(4) an elongation at break of the functional polymer is in a range of 500% to 1200%.

15. The secondary battery according to claim 10, wherein at least one of the following conditions is satisfied:
(1) based on a mass of the heat-shrink sleeve film, a mass percentage of the functional polymer is in a range of 10 wt % to 50 wt %, and a mass percentage of the framework material is in a range of 40 wt % to 88 wt %; or
(2) a thickness of the heat-shrink sleeve film is 40 μm to 120 μm.

16. The secondary battery according to claim 10, wherein the framework material comprises at least one of polyethylene terephthalate, polybutylene terephthalate, or polytrimethylene terephthalate; and a crystallinity of the framework material is in a range of 5% to 55%.

17. The secondary battery according to claim 10, wherein at least one of the following conditions is satisfied:
(1) a transverse shrinkage rate of the heat-shrink sleeve film is in a range of 40% to 50%;
(2) a longitudinal shrinkage rate of the heat-shrink sleeve film is in a range of 2% to 8%; or
(3) a residual shrinkage rate of the heat-shrink sleeve film is in a range of 2.5% to 5.5%.

18. The secondary battery according to claim 10, wherein the heat-shrink sleeve film further comprises a coloring material;
the coloring material comprises polyethylene terephthalate-1,4-cyclohexanedimethanol ester and/or color powder; and
based on a mass of the heat-shrink sleeve film, a mass percentage of the coloring material is in a range of 2 wt % to 10 wt %.

19. The secondary battery according to claim 10, wherein a glass transition temperature of the heat-shrink sleeve film is in a range of 30° C. to 40° C.

20. The secondary battery according to claim 10, wherein a mass percentage of the framework material is in a range of 65 wt % to 70 wt %; or a mass percentage of the functional polymer is in a range of 20 wt % to 25 wt %.
